(19) United States
(12) Patent Application Publication
(10) Pub. No.: US 2024/0284927 A1
(43) Pub. Date: Aug. 29, 2024

(54) PLANT BASED FOAMING CREAMER

(71) Applicant: SOCIETE DES PRODUITS NESTLE S.A., Vevey (CH)

(72) Inventors: TIMOTHY JAMES WOOSTER, Orbe (CH); MARINA BORTOLIN, Lausanne (CH)

(21) Appl. No.: 18/564,882

(22) PCT Filed: May 31, 2022
(86) PCT No.: PCT/EP2022/064688

§ 371 Date: Nov. 28, 2023

(30) Foreign Application Priority Data
May 31, 2021 (EP) 21176879.1

(51) Int. Cl. A23C 11/10; A23F 5/40; A23L 9/20

(52) U.S. Cl. CPC A23C 11/103; A23F 5/40; A23L 9/24

(57) ABSTRACT

The invention relates to a method of making a plant based creamer, said method comprising dissolving a plant protein in water to form a plant protein mixture; dispersing triglyceride in the plant protein mixture; homogenizing the plant protein mixture to form an emulsion; applying a thermal treatment to the emulsion; homogenizing the thermal treated emulsion to form a plant based liquid; and spray drying the plant based liquid to form a powder, wherein an emulsifier is added to either the plant protein mixture or to the triglyceride prior to the dispersing of the triglyceride in the plant protein mixture.

### FIELD OF INVENTION

The present invention relates to plant based foaming creamer compositions and to processes for producing plant based foaming creamer compositions.

### BACKGROUND OF INVENTION

Creamers are widely used as whitening agents with hot and cold beverages such as, for example, coffee, cocoa, tea, etc. They are commonly used in place of milk and/or dairy cream. Creamers may come in a variety of different flavours and provide mouthfeel, body, and a smooth texture. They can be in liquid or powder forms. For some applications, e.g. for the easy preparation of cappuccino-type coffee beverages, creamers that produce a high amount of foam on top of a beverage is desired. WO 01/08504 discloses a foaming ingredient which contains gas under pressure and produces a high amount of foam when reconstituted in water. Such a foaming ingredient may be used as part of a foaming creamer, e.g. in an instant cappuccino beverage powder.

Both consumers and governments seek foods that have a lower environmental impact and/or do not contain ingredients derived from animals. As such, consumers are seeking to have plant based alternatives to conventional dairy based products such as foaming powdered creamers. In addition, many consumers seek to have the same pleasant mouthfeel, creamy texture and rich foam texture with a plant based alternative compared to the conventional dairy product.

However, powdered “non-dairy” coffee creamers often utilise dairy proteins such as casein as the protein component essential for well dispersing and stabilising the fat droplets. The casein is also responsible for stabilising the foam. The protein plays a critical role in ensuring good emulsification of the oil, whilst avoiding undesirable coagulation of the emulsion during manufacturing and/or protein in the beverage to which the protein is added. The challenge with plant proteins is that their native function is as storage proteins in low moisture environments. As such, plant proteins have a tendency to i) aggregate during the manufacture of emulsion base creamers and ii) aggregate when added to acidic coffee. The aggregation of the plant based creamer upon addition to acidic hot beverages also limits the appearance/volume of foam generated from the gassed creamer. These defects severely limit the ability to manufacture plant base powdered creamer and severely limit the consumers enjoyment of said (foaming) powered creamer.

There is therefore a need in the art for a means to create a plant based powdered creamer that does not aggregate during manufacturing and/or when added to an acidic hot beverage thereby enabling a rich texture.

### SUMMARY OF THE INVENTION

In a first aspect, the invention relates to a method of making a plant based creamer, said method comprising dissolving a plant protein in water to form a plant protein mixture; forming an emulsion; forming a plant based liquid; and drying to form a powder from the plant based liquid.

In a second aspect, the invention relates to a foaming or non-foaming plant based creamer made according to the invention.

In a third aspect, the invention relates to a beverage made from a foaming or non-foaming plant based creamer made according to the invention.

### EMBODIMENTS OF THE INVENTION

The invention relates in general to a method of making a plant based creamer.

In one embodiment, said method comprises dissolving a plant protein in water to form a plant protein mixture; forming an emulsion; forming a plant based liquid; and drying to form a powder from the plant based liquid.

In one embodiment, said method comprises dissolving a plant protein in water to form a plant protein mixture; dispersing triglyceride in the plant protein mixture; homogenizing the plant protein mixture to form an emulsion; applying a thermal treatment to the emulsion; homogenizing the thermal treated emulsion to form a plant based liquid; and spray drying the plant based liquid to form a powder, wherein an emulsifier is added to either the plant protein mixture or to the triglyceride prior to the dispersing of the triglyceride in the plant protein mixture.

In one embodiment, said method comprises dissolving a fractionated plant protein in water to form a plant protein mixture; dispersing triglyceride in the plant protein mixture; homogenizing the plant protein mixture to form an emulsion; applying a thermal treatment to the emulsion; homogenizing the thermal treated emulsion to form a plant based liquid; and spray drying the plant based liquid to form a powder, wherein an emulsifier is added to either the plant protein mixture or to the triglyceride prior to the dispersing of the triglyceride in the plant protein mixture.

In one embodiment, said method comprises dissolving a dry fractionated plant protein in water to form a plant protein mixture; dispersing triglyceride in the plant protein mixture; homogenizing the plant protein mixture to form an emulsion; applying a thermal treatment to the emulsion; homogenizing the thermal treated emulsion to form a plant based liquid; and spray drying the plant based liquid to form a powder, wherein an emulsifier is added to either the plant protein mixture or to the triglyceride prior to the dispersing of the triglyceride in the plant protein mixture.

In one embodiment, said method comprises dissolving a dry fractionated plant protein in water to form a plant protein mixture with a pH between 6.5 and 9; dispersing triglyceride in the plant protein mixture; homogenizing the plant protein mixture to form an emulsion; applying a thermal treatment to the emulsion; homogenizing the thermal treated emulsion to form a plant based liquid; and spray drying the plant based liquid to form a powder, wherein an emulsifier is added to either the plant protein mixture or to the triglyceride prior to the dispersing of the triglyceride in the plant protein mixture.

In one embodiment, said method comprises dissolving a dry fractionated plant protein in water to form a plant protein mixture with a pH between 6.5 and 9; optionally adding a hydrocolloid to the plant protein mixture; dispersing triglyceride in the plant protein mixture; homogenizing the plant protein mixture to form an emulsion; applying a thermal treatment to the emulsion; homogenizing the thermal treated emulsion to form a plant based liquid; and spray drying the plant based liquid to form a powder, wherein an emulsifier is added to either the plant protein mixture or to the triglyceride prior to the dispersing of the triglyceride in the plant protein mixture.

In one embodiment, said method comprises
a. Dissolving 2 to 8 wt % dry fractionated plant protein in water to form a plant protein mixture with a pH between 6.5 and 9, preferably 6.7 and 8;
b. Optionally adding a hydrocolloid to the plant protein mixture;
C. Dispersing triglyceride in the plant protein mixture;
d. Homogenizing the plant protein mixture to form an emulsion;
e. Applying a thermal treatment to the emulsion;
f. Homogenising the thermal treated emulsion to form a plant based liquid; and
g. Spray drying the plant based liquid to form a powder.
   wherein an emulsifier is added to either the plant protein mixture or to the triglyceride prior to the dispersing of the triglyceride in the plant protein mixture.

In one embodiment, the dry fractionated plant protein is derived from faba bean, pea, adzuki bean, chickpea, oat, or lentil.

In one embodiment, the dry fractionated plant protein is an air classified plant protein.

In one embodiment, the dry fractionated protein is a plant protein concentrate.

In one embodiment, the dry fractionated plant protein is faba bean protein, preferably a faba bean protein concentrate. In one embodiment, the faba bean protein concentrate comprises between 50 to 70% protein, preferably about 60% protein.

In one embodiment, the dry fractionated plant protein is pea protein, preferably a pea protein concentrate. In one embodiment, the pea protein concentrate comprises between 45 to 65% protein, preferably about 55% protein.

In one embodiment, the dry fractionated plant protein is adzuki bean protein, preferably an adzuki bean protein concentrate. In one embodiment, the adzuki bean protein concentrate comprises between 45 to 65% protein, preferably about 55% protein.

In one embodiment, sodium ascorbate is dissolved in the plant protein mixture before applying a thermal treatment to the emulsion.

In one embodiment, a non-crystalizing carbohydrate is added to the plant protein mixture, for example glucose syrup, or maltodextrin, preferably glucose syrup.

In one embodiment, the triglyceride is a vegetable oil, animal fat, milk fat, fish oil, algal oil, sunflower oil, olive oil, canola oil, cotton seed oil, palm fat, palm stearin, palm kernel oil, corn oil, coconut oil, and/or high oleic acid sunflower oil, any solid fat stock such as refined coconut oil, anhydrous milk fat, hydrogenated vegetable oil, tallow, lard, any nut butter/oil such as almond butter, peanut butter, walnut butter, cashew butter and/or hydrogenated or partially hydrogenated fats.

Preferably, the triglyceride is a plant based fat source, for example vegetable oils, algal oil, sunflower oil, olive oil, canola oil, cotton seed oil, palm fat, palm stearin, palm kernel oil, corn oil, coconut oil, and/or high oleic acid sunflower oil, any solid fat stock such as refined coconut oil, anhydrous milk fat, hydrogenated vegetable oil, any nut butter/oil such as almond butter, peanut butter, walnut butter, cashew butter and/or hydrogenated or partially hydrogenated fats.

In one embodiment, the triglyceride is a solidifying fat, for example coconut fat. In one embodiment, the triglyceride is selected from sunflower oil, corn oil, canola oil, or palm fat.

In one embodiment, a citrate derived calcium chelation agent is dissolved in the plant protein mixture before applying a thermal treatment to the emulsion, wherein the agent is selected from citric acid, lemon juice, trisodium citrate or tripotassium citrate.

In one embodiment, an acidity regulator is dissolved in the plant protein mixture before applying a thermal treatment to the emulsion, wherein the regulator is selected from sodium bicarbonate, potassium bicarbonate, calcium bicarbonate, sodium dihydrogen phosphate, trisodium phosphate, disodium hydrogen phosphate.

In one embodiment, an acidity regulator is dissolved in the plant protein mixture before applying a thermal treatment to the emulsion, wherein the regulator is selected from sodium bicarbonate, potassium bicarbonate, calcium bicarbonate, potassium dihydrogen phosphate, tripotassium phosphate, or dipotassium hydrogen phosphate, preferably sodium bicarbonate.

In one embodiment, the emulsifier is a small molecule emulsifier, for example lecithin or modified lecithin, for example hydrolysed sunflower lecithin.

In one embodiment, the non-aggregated emulsion average particle size is between 0.2 to 2 μm for d[3,2] and 0.7 to 4 μm for d[4,3], as measured using particle size analysis.

In one embodiment, gas is added to the plant based liquid before spray drying, for example gas may be added to the plant based liquid under pressure before spray drying. Gas may be added to the plant based liquid after subjecting the plant based liquid to elevated pressure. This may be performed by introducing the gas at a pressure at least slightly above the pressure of the plant based liquid. The aqueous mixture may be gassed with a gas selected from the group consisting of nitrogen, air, carbon dioxide, nitrous oxide and argon. The gas may be nitrogen or argon. The plant based liquid may be at an elevated pressure of between 50 and 300 bar, for example between 80 and 200 bar, for further example between 100 and to 150 bar.

In one embodiment, nitrogen or argon gas is added to the plant based liquid before spray drying.

In one embodiment, the creamer has a bulk viscosity<100 mPa·s at 100 s-1 at 60° C.

In one embodiment, (i) the dry fractionated plant protein is faba bean protein concentrate; (ii) sodium ascorbate is dissolved in the plant protein mixture before applying a thermal treatment to the emulsion; (iii) the acidity regulator is sodium bicarbonate; and (iv) the calcium chelation agent is selected from citric acid, lemon juice, trisodium citrate or tripotassium citrate, preferably citric acid.

In one embodiment, said method comprises dissolving about 6.2 wt % dry fractionated faba protein concentrate, glucose syrup, sodium bicarbonate, citric acid, and sodium ascorbate in water to form a plant protein mixture with a pH of about 7.5; dispersing coconut fat comprising deoiled sunflower lecithin in the plant protein mixture; homogenizing the plant protein mixture to form an emulsion; applying a thermal treatment to the emulsion; homogenising the thermal treated emulsion to form a plant based liquid; and spray drying the plant based liquid to form a powder.

In one embodiment, the faba protein concentrate comprises about 60% protein. In one embodiment, about 1.5 wt % sodium bicarbonate is dissolved. In one embodiment, about 0.175 wt % sodium ascorbate is dissolved. In one embodiment, about 1 wt % citric acid is present in the plant protein mixture.

In one embodiment, said method comprises dissolving about 6.4 wt % dry fractionated pea protein concentrate, glucose syrup, sodium bicarbonate, citric acid, and sodium ascorbate in water to form a plant protein mixture with a pH of about 7.5; dispersing coconut fat comprising deoiled sunflower lecithin in the plant protein mixture; homogenizing the plant protein mixture to form an emulsion; applying a thermal treatment to the emulsion; homogenising the thermal treated emulsion to form a plant based liquid; and spray drying the plant based liquid to form a powder.

In one embodiment, the pea protein concentrate comprises about 55% protein. In one embodiment, about 1.5 wt % sodium bicarbonate is dissolved. In one embodiment, about 0.175 wt % sodium ascorbate is dissolved. In one embodiment, about 1 wt % citric acid was is present in the plant protein mixture.

In one embodiment, said method comprises dissolving about 6.4 wt % dry fractionated Adzuki bean protein concentrate, glucose syrup, sodium bicarbonate, citric acid, and sodium ascorbate in water to form a plant protein mixture with a pH of about 7.5; dispersing coconut fat comprising deoiled sunflower lecithin in the plant protein mixture; homogenizing the plant protein mixture to form an emulsion; applying a thermal treatment to the emulsion; homogenising the thermal treated emulsion to form a plant based liquid; and spray drying the plant based liquid to form a powder.

In one embodiment, the Adzuki bean protein concentrate comprises about 55% protein. In one embodiment, about 1.5 wt % sodium bicarbonate is dissolved. In one embodiment, about 0.175 wt % sodium ascorbate is dissolved. In one embodiment, about 1 wt % citric acid is present in the plant protein mixture.

The invention further relates to a foaming or non foaming plant based creamer powder made by a method according to the invention.

In one embodiment, said powder is a foaming plant based creamer powder having a porous structure. In one embodiment, said powder is a foaming plant based creamer powder having a powder tapped density of 100 to 700 g/L, preferably 100 to 500 g/L, more preferably 200 to 400 g/L.

In one embodiment, said powder is a foaming plant based creamer powder which does not undergo significant flocculation in coffee made with water containing up to 400 ppm calcium carbonate equivalent, and wherein the foam height is at least 2 mm.

The invention further relates to a plant based creamer powder made by a method according to the invention, wherein said powder is a non-foaming plant based creamer powder.

In one embodiment, said powder does not undergo flocculation in coffee made with water containing up to 400 ppm calcium carbonate equivalent.

The invention further relates to a beverage mix comprising the plant based creamer powder of the invention. The beverage mix may for example be a coffee mix comprising dried coffee extract and the plant based creamer powder of the invention.

The invention further relates to a beverage made from a plant based creamer powder according to the invention.

In one embodiment, the beverage is made using a beverage preparation device, for example a beverage preparation machine.

Beverage preparation devices (for example a beverage preparation machine, or an automated coffee machine) which accommodate portioned ingredients provide a convenient method of preparing beverages. Such portioned ingredients are generally packed in a container, configured for example as a pod, pad, sachet, pouch, capsule or the like. An aspect of the invention provides a container for use in a beverage preparation device, the container containing the plant based creamer of the invention. The container being for the preparation of a beverage when inserted into a beverage preparation device. The container may for example be a beverage capsule, among other configurations.

### DETAILED DESCRIPTION OF THE INVENTION

When a composition is described herein in terms of wt %, this means wt % of the total recipe, unless indicated otherwise.

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 45 to 55 should be construed as supporting a range of from 46 to 54, from 48 to 52, from 49 to 51, from 49.5 to 50.5, and so forth.

The term “vegan” refers to an edible composition which is entirely devoid of animal products, or animal derived products.

Plant protein sources based on faba, pea, oat, adzuki bean, chickpea, lentil, cowpea, pinto bean, mung bean, common bean, kidney beans, navy beans or similar high carbohydrate (>30 wt %)-low fat (<15%) crops or the like may be used.

The term “emulsifier” refers to an emulsifier which can be synthetic, natural, or modified from natural sources, for example lecithin, hydrolysed lecithin, monoglyceride, modified monoglycerides such as datem or citrem, sodium sterol lactalate, polysorbate 80.

Sodium ascorbate alternatives include vitamin C, sodium ascorbate, calcium ascorbate, vitamin C palmitate, fruit juices rich in vitamin C (>500 mg vitamin C per 100 mL), acerola extract, sodium bisulfite, iodine, potassium iodide, sorbic acid, potassium sorbate, sulfite derivatives such as sodium sulfite, sodium hydrogen sulfite, sodium metabisulfite, potassium metabisulfite, calcium sulfite, calcium hydrogen sulfite.

As used herein, the term “flocculation” is a process by which colloidal particles come out of suspension to sediment under the form of floc or flake.

Glucose syrup is typically manufactured by the hydrolysis of starch. The glucose syrup may have a dextrose equivalence (DE) between 25 and 63. Dextrose equivalence is an indication of the degree of hydrolysis applied to the starch, a 100DE syrup is completely hydrolysed to dextrose (glucose).

Buffer alternatives include dipotassium phosphate, trisodium citrate, tripotassium citrate, tripotassium phosphate, sodium bicarbonate, baking soda, bicarbonate of soda, disodium phosphate, trisodium phosphate, monopotassium phosphate, citric acid and lemon juice.

A legume is a plant in the family Fabaceae (or Leguminosae), the seed of such a plant (also called pulse). Legumes are grown agriculturally, primarily for human consumption, for livestock forage and silage, and as soil-enhancing green manure. As used herein, the term “legume” may include: pea, faba bean, chickpea, lentils, kidney beans, navy beans, pinto beans, haricot beans, lima beans, butter beans, azuki beans, mung beans, golden gram, green gram, black gram, urad, scarlet runner beans, rice beans, garbanzo beans, cranberry beans, lima beans, green peas, snow peas, snap peas, split peas and black-eyed peas. Preferably, the legume is selected from pea, faba bean, chickpea, and lentils.

Vicia faba, also known in the culinary sense as the broad bean, fava bean, or faba bean, or faba, is a species of flowering plant in the pea and bean family Fabaceae.

The skilled person will appreciate that the various features of each method embodiment described herein are applicable to product embodiments, use embodiments, and so forth.

By way of example and not limitation, the following examples are illustrative of various embodiments of the present invention.

### EXAMPLES

A key step in the manufacture of a powdered creamer is the creation of a liquid concentrate which is subsequently dried to form a powder. In order to perform in manufacturing processes and in cup the creamer needs to; i) have a bulk viscosity<100 mPa·s at 100 s⁻¹ at 60° C. and needs to have visible aggregates and/or not cream in cup during preparation. Such features can be quantified by image analysis or particle size analysis.

### Example 1

### Reference Plant Based Creamer

A reference plant based creamer liquid concentrate was prepared by dissolving 13.524 kg of glucose syrup (DE 29), 1.240 kg of Faba concentrate (60% protein Vitessence Pulse 3600), 300 g of dipotassium phosphate, 100 g of trisodium citrate, 35 g of sodium ascorbate in 30 kg of deionised water at 65° C. with stirring. Once all ingredients were well dissolved, the pH was adjusted to 7.5 and 4.8 kg of melted refined coconut fat (mp 22-24) was added using a homogeniser. A fine emulsion was then created by passing this mixture through a high pressure homogeniser.

A powder was created from this mixture by spray drying.

A foaming powder was created from this mixture by dissolving nitrogen gas into this liquid creamer concentrate under pressure before the liquid creamer concentrate was passed through the spray drier nozzle.

### Example 2

### Cappuccino Beverage Comprising Reference Creamer

A reference powdered cappuccino beverage composition was prepared by pouring hot water to dissolve a dry mix of soluble coffee, creamer and sugar. The composition was as shown in the table below:

TABLE 1

| Ingredient | Cappuccino Ref (g) | |
|---|---|---|
| Plant based creamer | 10 | g |
| Sugar | 3.15 | g |
| coffee | 1.85 | g |

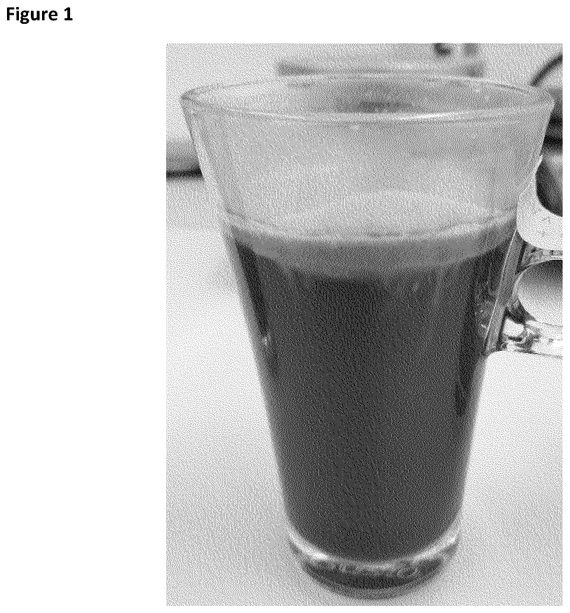

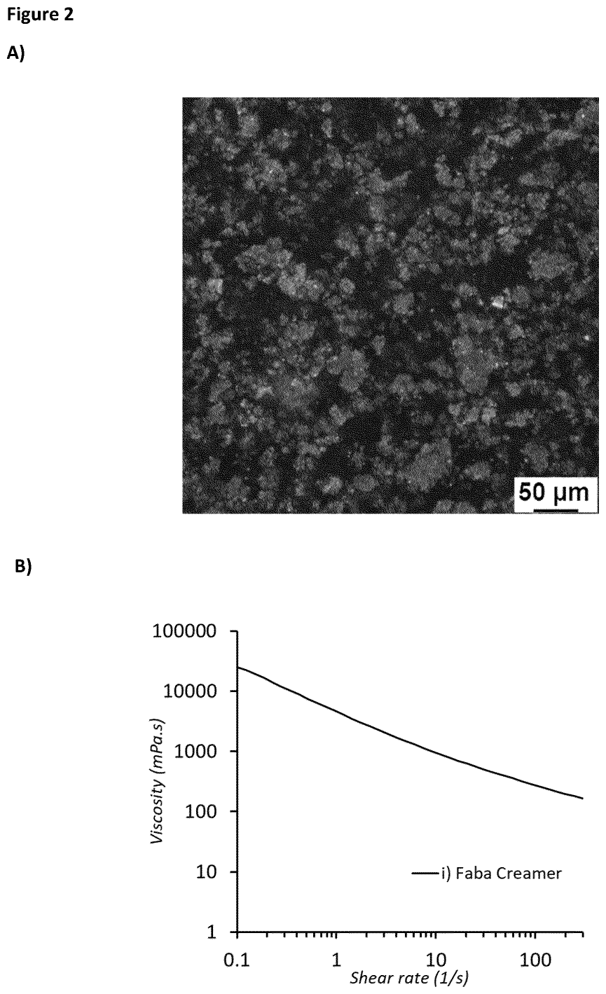

The resulting cappuccino is presented in FIG. 1. It is apparent that there is phase separation in the cup, with the fat component of the creamer rising to the top of the cup and resting just beneath the foam layer. The origin of the creaming effect was investigated using confocal laser scanning microscopy of the liquid concentrate before drying (FIG. 2A) which showed large aggregates of protein and emulsion droplets. This aggregation caused considerable viscosity of the liquid creamer concentrate meaning that the creamer liquid concentrate had a viscosity of 265 mPa·s (@100s⁻¹). FIG. 2B shows the rheological flow curve before spray drying of the liquid concentrate.

### Example 3

### Faba Concentrate Based Creamer of the Invention

A non aggregated plant based creamer liquid concentrate was prepared by dissolving 66.9 kg of glucose syrup (DE 29), 6.2 kg of Faba concentrate (60% protein Vitessence Pulse 3600), 1.5 kg of sodium bicarbonate, 1 kg of citric acid, 175 g of sodium ascorbate in 100 kg of deionised water at 65° C. with stirring. Once all ingredients were well dissolved, the pH was adjusted to 7.5 and 24 kg of melted refined coconut fat (mp 22-24) containing 250 g of deoiled sunflower lecithin was added using a homogeniser. A fine emulsion was then created by passing this mixture through a high pressure homogeniser.

A powder was created from this mixture by spray drying.

A highly stable high foaming powder was created from this mixture by dissolving nitrogen gas into this liquid creamer concentrate under pressure before the liquid creamer concentrate was passed through the spray drier nozzle.

### Example 4

### Cappuccino Beverage Comprising Creamer of the Invention

A powdered cappuccino beverage composition of the present invention was prepared by pouring hot water to dissolve a dry mix of soluble coffee, creamer and sugar. The composition was as shown in the table 2.

TABLE 2

| Ingredient | Cappuccino Ref (g) | |
|---|---|---|
| Plant (Faba) based creamer of example 3 | 10 | g |
| Sugar | 3.15 | g |
| coffee | 1.85 | g |

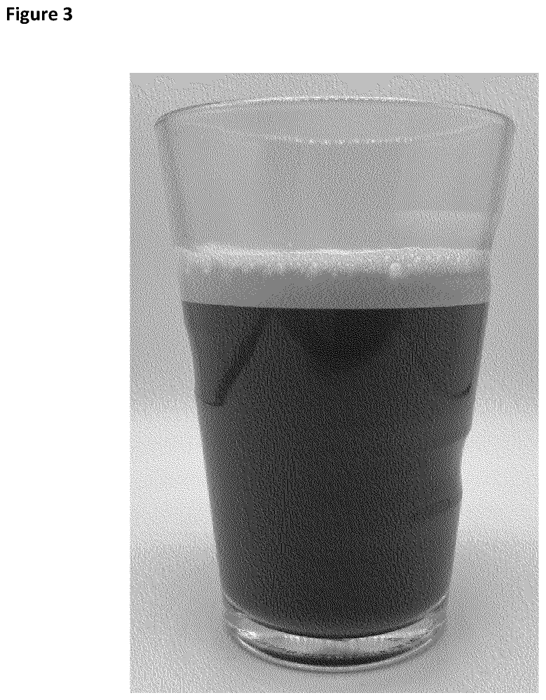

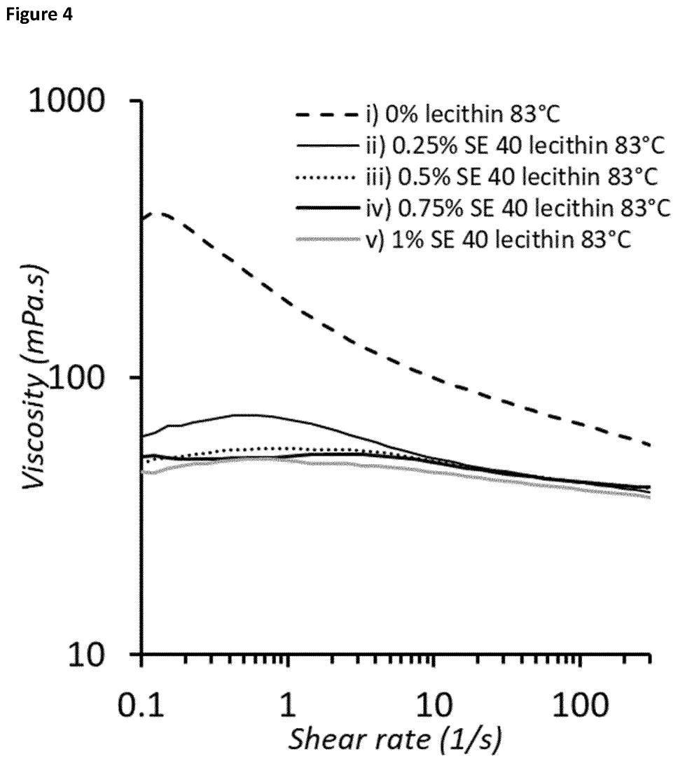

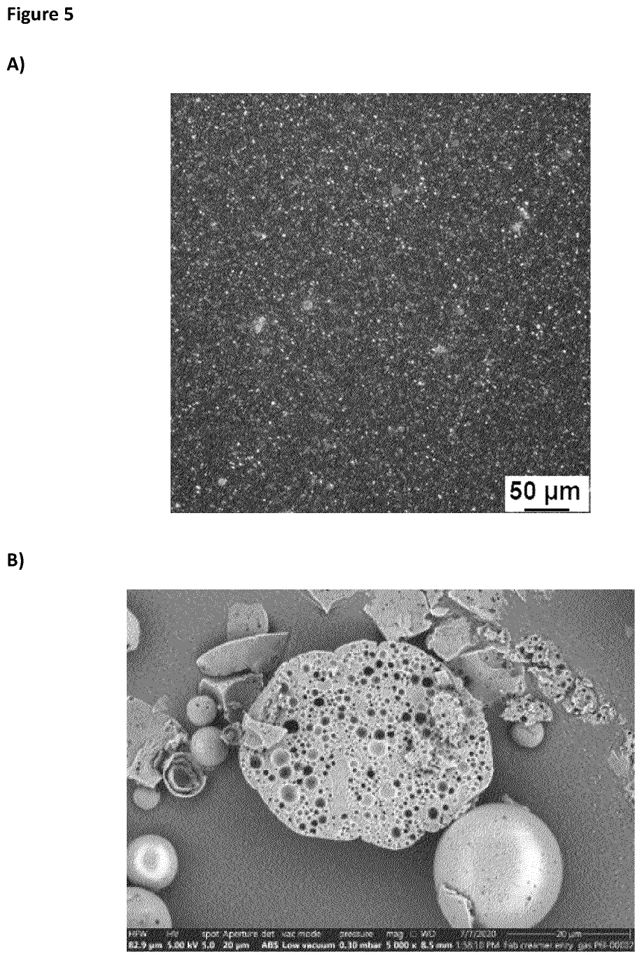

The resulting cappuccino is presented in FIG. 3. It is apparent that the resulting coffee has a homogeneous distribution of fat throughout the coffee phase and a fine high volume micro-foam layer on top of the coffee. The viscosity of the liquid creamer concentrate was moderately low (FIG. 4) meaning that the creamer liquid concentrate was easily atomised in the spray drier. Confocal laser scanning microscopy of the liquid concentrate before drying (FIG. 5A) which shows an even distribution of fine emulsion droplets. The microstructure of the powder resulting from the spray drying of the gassed liquid shows a highly porous microstructure with a number of pores (FIG. 5B).

### Example 5

### In Coffee Stability of the Creamer of the Invention

An essential feature of any (dairy or plant based) creamer is that it is well dispersed/does not aggregate when mixed with coffee. A creamer that is well dispersed/does not aggregate will add to the visual appeal of the coffee by acting to whiten the coffee. The aggregation of plant-based creamer in coffee is affected by the acidity of the coffee and the hardness of the water used to prepare the coffee. In order to have well performing creamer, it must not aggregate in various water hardness/coffee acidities that the consumer might encounter.

As such, resistance to aggregation in waters of differing hardness is a critical performance criterion for a (plant based) creamer. The present invention ensures stability of the described plant-based creamer in waters of high hardness through the clever combination of a chelation agent and acidity regulator.

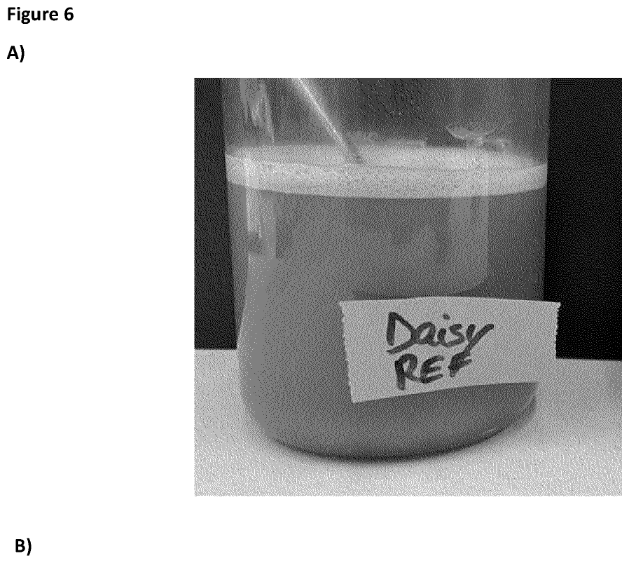

It will be appreciated that such a system required intelligent design and the design is not obvious to those skilled in the art. For example, Table 3 describes two powdered creamers that were created with the same combination of chelation agent (citrate) and acidity regulatory. When mixed with coffee at the ratios described in Table 1 they had the flocculation stability depicted in FIG. 6. The rice protein stabilised creamer was stable in coffee at 85° C. prepared with 400 ppm water hardness. However, the Faba concentrate stabilised creamer underwent flocculation in coffee at 85° C. prepared with 400 ppm water hardness

Table 3 shows the final powder composition of plant based creamer when mixed with coffee at 400 ppm water hardness has the flocculation stability described in FIG. 6.

TABLE 3

| Ingredient | Content |
|---|---|
| FABA Conc. 3600 | 6.20% |
| Na Ascorbate | 0.18% |
| Glucose Syrup DE 29 | 67.0% |
| Coconut Fat - refined | 24.0% |
| Sodium bicarbonate | 1.40% |
| Citric Acid | 0.75% |
| Lecithin | 0.5% |
| | 100% |

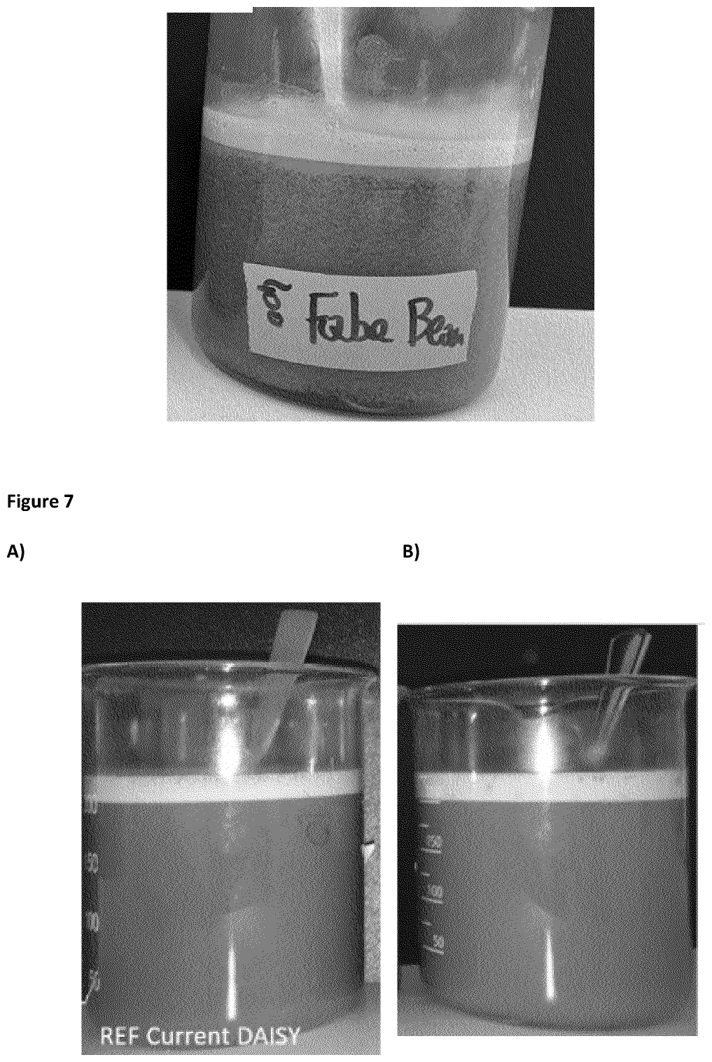

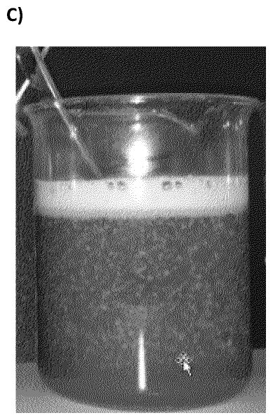

Detailed studies were conducted to understand the flocculation phenomena of Faba based creamers and a new system of calcium chelation agent and acidity regulator were designed to ensure stability in acidic hot coffee at 400 ppm water hardness. Table 4 describes three powdered creamers that were created with this new combination of chelation agent (citrate) and acidity regulatory. When mixed with coffee at the ratios described in Table 1 they had the flocculation stability depicted in FIG. 7. With this new intelligent combination of chelation agent and acidity regulatory the Faba concentrate stabilised creamer was stable in coffee at 85° C. prepared with 400 ppm water hardness. The rice protein stabilised creamer was also stable in coffee at 85° C. prepared with 400 ppm water hardness. However, the pea isolate stabilised creamer underwent flocculation in coffee at 85° C. prepared with 400 ppm water hardness.

Table 4 shows the final powder composition of plant based creamer when mixed with coffee at 400 ppm water hardness has the flocculation stability described in FIG. 7, which shows the flocculation stability of A) the hydrolysed rice protein based creamer, B) the faba concentrate based creamer, and C) the pea isolate based creamer.

TABLE 4

| Ingredient | Content | Ingredient | Content | Ingredient | Content |
|---|---|---|---|---|---|
| Rice Protein | 2.60% | FABA Conc. 3600 | 6.20% | Pea Isolate (Piscane C9) | 2.50% |
| Hydrosylate | | Na Ascorbate | 0.18% | Na Ascorbate | 0.18% |
| Glucose Syrup DE 29 | 72.0% | Glucose Syrup DE 29 | 60.0% | Glucose Syrup DE 29 | 69.0% |
| Coconut Fat - refined | 23.0% | Coconut Fat - refined | 28.0% | Coconut Fat - refined | 24.0% |
| Sodium bicarbonate | 1.30% | Sodium bicarbonate | 3.00% | Sodium bicarbonate | 3.00% |
| Citric Acid | 0.70% | Citric Acid | 2.00% | Citric Acid | 0.75% |
| Lecithin | 0.5% | Lecithin | 0.5% | Lecithin | 0.5% |
| | 100% | | 100% | | 100% |

### Example 6

### Pea Concentrate Based Creamer of the Invention

A non aggregated plant based creamer liquid concentrate was prepared by dissolving 66.9 kg of glucose syrup (DE 29), 6.4 kg of Pea concentrate (55% protein Vitessence Pulse 1550), 1.5 kg of sodium bicarbonate, 1 kg of citric acid, 175 g of sodium ascorbate in 100 kg of deionised water at 65° C. with stirring. Once all ingredients were well dissolved, the pH was adjusted to 7.5 and 24 kg of melted refined coconut fat (mp 22-24) containing 250 g of deoiled sunflower lecithin was added using a rotor stator homogeniser. A fine emulsion was then created by passing this mixture through a high pressure homogenizer at 380 bar/80 bar.

A powder was created from this mixture by spray drying using a Niro production minor spray drier.

A highly stable high foaming powder was created from this mixture by dissolving nitrogen gas into this liquid creamer concentrate under pressure before the liquid creamer concentrate was passed through the spray drier nozzle.

### Example 7

### Cappuccino Beverage Comprising Creamer of the Invention

A powdered cappuccino beverage composition of the present invention was prepared by pouring hot water to dissolve a dry mix of soluble coffee, creamer and sugar. The composition was as shown in the table 5.

TABLE 5

| Ingredient | Cappuccino Ref (g) | |
|---|---|---|
| Plant (pea) based creamer of example 6 | 10 | g |
| Sugar | 3.15 | g |
| coffee | 1.85 | g |

The resulting coffee had a homogeneous distribution of fat throughout the coffee phase and a fine high volume micro-foam layer on top of the coffee. Confocal laser scanning microscopy of the liquid concentrate before drying showed an even distribution of fine emulsion droplets. The viscosity of the liquid creamer concentrate was moderately low meaning that the creamer liquid concentrate was easily atomised in the spray drier. The microstructure of the powder resulting from the spray drying of the gassed liquid showed a highly porous microstructure with a number of pores.

### Example 8

### Adzuki Bean Concentrate Based Creamer of the Invention

A non aggregated plant based creamer liquid concentrate was prepared by dissolving 66.9 kg of glucose syrup (DE 29), 6.4 kg of Adzuki bean (red mung bean) concentrate (55% protein experimental material), 1.5 kg of sodium bicarbonate, 1 kg of citric acid, 175 g of sodium ascorbate in 100 kg of deionised water at 65° C. with stirring. Once all ingredients were well dissolved, the pH was adjusted to 7.5 and 24 kg of melted refined coconut fat (mp 22-24) containing 250 g of deoiled sunflower lecithin was added using a rotor stator homogeniser. A fine emulsion was then created by passing this mixture through a high pressure homogenizer at 380 bar/80 bar.

A powder was created from this mixture by spray drying using a Niro production minor spray drier.

A high stable high foaming powder was created from this mixture by dissolving nitrogen gas into this liquid creamer concentrate under pressure before the liquid creamer concentrate was passed through the spray drier nozzle.

### Example 9

### Cappuccino Beverage Comprising Creamer of the Invention

A powdered cappuccino beverage composition of the present invention was prepared by pouring hot water to dissolve a dry mix of soluble coffee, creamer and sugar. The composition was as shown in the table 6

TABLE 6

| Ingredient | Cappuccino Ref (g) | |
|---|---|---|
| Plant (Adzuki) based creamer of example 8 | 10 | g |
| Sugar | 3.15 | g |
| coffee | 1.85 | g |

The resulting coffee has a homogeneous distribution of fat throughout the coffee phase and a fine high volume micro-foam layer on top of the coffee. Confocal laser scanning microscopy of the liquid concentrate before drying showed an even distribution of fine emulsion droplets. The viscosity of the liquid creamer concentrate was moderately low meaning that the creamer liquid concentrate was easily atomised in the spray drier. The microstructure of the powder resulting from the spray drying of the gassed liquid shows a highly porous microstructure with a number of pores.

1. A method of making a plant based creamer, said method comprising
Dissolving 2 to 8 wt % dry fractionated plant protein in water to form a plant protein mixture with a pH between 6.5 and 9;
Dispersing triglyceride in the plant protein mixture;
Homogenizing the plant protein mixture to form an emulsion;
Applying a thermal treatment to the emulsion;
Homogenising the thermal treated emulsion to form a plant based liquid; and
Spray drying the plant based liquid to form a powder,
wherein a small molecule emulsifier is added to either the plant protein mixture or to the triglyceride prior to the dispersing of the triglyceride in the plant protein mixture.

2. The method according to claim 1, wherein the dry fractionated plant protein is derived from a plant selected from the group consisting of faba bean, pea, chickpea, oat, and lentil.

3. The method according to claim 1, wherein the dry fractionated plant protein is an air classified plant protein.

4. The method according to claim 1, wherein the dry fractionated plant protein is faba bean protein, preferably a faba bean protein concentrate.

5. The method according to claim 1, wherein sodium ascorbate is dissolved in the plant protein mixture before applying a thermal treatment to the emulsion.

6. The method according to claim 1, wherein a citrate derived calcium chelation agent is dissolved in the plant protein mixture before applying a thermal treatment to the emulsion, wherein the agent is selected from the group consisting of citric acid, lemon juice, trisodium citrate and tripotassium citrate.

7. The method according to claim 1, wherein an acidity regulator is dissolved in the plant protein mixture before applying a thermal treatment to the emulsion, wherein the regulator is selected from the group consisting of sodium bicarbonate, potassium bicarbonate, calcium bicarbonate, sodium dihydrogen phosphate, and disodium hydrogen phosphate.

8. The method according to claim 1, wherein the small molecule emulsifier is a lecithin or modified lecithin.

9. The method according to claim 1, wherein the emulsion average particle size is between 0.2 to 2 μm for d[3,2] and 0.7 to 4 μm for d[4,3], as measured using particle size analysis.

10. A method of according to claim 1, wherein nitrogen or argon is added to the plant based liquid before spray drying.

11-15. (canceled)
